(19) United States
(12) Patent Application Publication
(10) Pub. No.: US 2006/0098242 A1
(43) Pub. Date: May 11, 2006

(54) IMAGE PROCESSING SYSTEM AND RELATED METHOD FOR SCANNING AND GENERATING AN IMAGE

(76) Inventor: Shih-Yen Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/904,316

(22) Filed: Nov. 3, 2004

(51) Int. Cl. H04N 1/04

(52) U.S. Cl. 358/474; 358/498

(57) ABSTRACT

A method for processing an image includes moving a coded device, generating a first digital signal by detecting movement of the coded device, generating a second digital signal according to the first digital signal, generating a first analog signal according to the first digital signal, generating a second analog signal according to the second digital signal, generating value sets from the first and second analog signals and generating an image according to the value sets.

### BACKGROUND OF INVENTION

1. Field of the Invention

The present invention relates to an image processing system, and more specifically, an image processing system and its related method for scanning and generating an image.

2. Description of the Prior Art

With the constant development of computer technology comes continuous pressure on existing high-tech peripheral devices to perform better, faster, and at the same time, be cheaper and more compact.

Image processing systems such as scanners, printers and other peripherals are considered especially important due to their direct operation by humans.

An image processing system is a type of peripheral device such as a scanner, which handles the scanning and generation of images. It is usually made of tangible components such as: a central processing unit, a media feeding unit, a scanning unit and a data processing unit.

The media feeding unit is an essential part of the image processing system. The role of the media feeding unit is to physically advance the scannable media through the scanner, and to time the movement of the media with the scanning operation itself, so that the scanner scans, or “takes a picture of”, the media at the right time, and at the appropriate position.

Please refer to FIG. 1 where an image processing system 100 is shown. The image processing system 100 comprises a CPU 102 which is connected to, and controls the operation of, a media feeding unit 104, a scanning unit 106 and a data processing unit 108. The media feeding unit 104, the scanning unit 106 and the data processing 108 are also connected to each other. Media feeding unit 104 draws in a media 103, while the data processing unit 108 produces an image 110.

Please refer to FIG. 2 where the media feeding unit 104 is illustrated. The media feeding unit 104 is controlled by a control unit 202 which is connected to, and induces, an actuator 204 to turn for the purpose of pulling in media 103. The actuator 204 is connected to, and moves synchronously with, a code wheel 206. The actuator 204, which is similar to a gear that drags the paper in, is further connected to an encoder 208, which generates digital signals as a result of the movement of the code wheel 206, as it will be explained below. The encoder 208 is also connected to a digitizer 210, whose purpose is to generate value sets from the encoded signals provided by the encoder 208. Finally, the digitizer 210 is connected to the scanning unit 106.

Please refer to FIG. 3 in conjunction with FIG. 1 and FIG. 2. FIG. 3 contains the code wheel 206, which is made up of a plurality of opaque regions 304 and a plurality of transparent regions 306, with the regions alternating between transparent and opaque. The diagram also illustrates a light source 300, which emits light beams perpendicular to the code wheel's 206 opaque regions 304 and transparent regions 306. A light beam 316 is captured by a sensor 302 only if it passes through a transparent region 306 of the code wheel 206. Conversely, a light beam 314 that hits an opaque region 304 of the code wheel 206 is unable to penetrate it and consequently is not caught by the sensor 302. If the sensor 302 successfully receives the light beam 316 from the light source 300, then the encoder 208 generates a digital signal 308 as illustrated.

The digital signal 308 has two possible values: a 1 value 310 and a 0 value 312. The 1 value 310 is generated if the sensor 302 receives a light beam 314, while a 0 value is generated if the light beam 316 cannot reach the sensor 302.

Hence with the prior art's approach to scanning, the scanning unit 106 will scan the current zone of the media every time the digital signal's 308 value changes from a 0 to a 1, and vice-versa.

Please note that in FIG. 3, the illustrations of the code wheel 206 and digital signal 308 are symmetrical with respect to each other, so that a filled square in the code wheel's 206 representation corresponds to a “top line” or a 1 value in the digital signal's 308 representation. On the other hand, a blank square in the code wheel's 206 representation corresponds to a “bottom line” or a 0 value in the digital signal's 308 representation.

Unfortunately, this method of scanning images has a serious drawback as far as resolution is concerned. For example, suppose the resolution is 600 dpi (dots per inch). In this case the media is moved by 1/600^{th} of an inch between each scan, meaning that every section being scanned is 1/600^{th} of an inch away from the next one being scanned. This limitation is created by the physical structure of the code wheel 206, which can only accommodate a specific number of alternating opaque/transparent regions—enough regions to allow for the scanning of 600 “lines” per inch. Hence, the number of times that the scanning mechanism would be triggered (i.e. take a “picture” of the current zone of the media) is directly proportional to number of the different regions on the code wheel 206.

One way to address this issue, and increase resolution is to feed the media slower through the scanner. This could be done by having the actuator 204 turn at a different rate than the code wheel, which would be spinning faster. Consequently, the scanner would be able to scan the media more times than before, therefore increasing the resolution. Unfortunately, this method, while increasing resolution, by slowing down the feeding mechanism, would also slow down the scanning operation itself since the media would be scanned slower. Since scanning speed is of vital importance in the image processing field, this is not a viable solution to the problem.

Another option would be to increase the size of the code wheel, in order to accommodate an increased number transparent/opaque regions, yet this tactic would augment the bulkiness of the scanner, henceforth it isn't practical either.

### SUMMARY OF INVENTION

It is therefore a primary objective of the claimed invention to provide an image processing system, and its related method, for scanning and generating an image in a manner that would solve the above-mentioned problems of the prior art.

According to the claimed invention, a method for processing an image comprises moving a coded device, generating a first digital signal by detecting movement of the coded device and then generating a second digital signal according to the first digital signal. The method also comprises generating a first analog signal according to the first digital signal, generating a second analog signal according to the second digital signal and generating value sets from the first and second analog signals. Finally, the method comprises generating an image according to the value sets.

Also according to the claimed invention, an image processing system comprises a media feeding unit, a scanning unit for scanning a document and a data processing unit connected to the scanning unit for generating an image according to the value sets. The media feeding unit comprises an actuator, a coded device connected with the actuator, an encoder for generating encoded signals based on movements of the coded device, a converter connected with the encoder for converting encoded signals into analog signals and a digitizer for generating value sets from the analog signals.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a prior art image processing system.

FIG. 2 is a block diagram of media feeding unit of a prior art image processing system.

FIG. 3 is a time frame diagram of a coded device and its corresponding digital signal of a prior art image processing system.

FIG. 4 is a block diagram of media feeding unit of the image processing system according to current invention.

FIG. 5 is a time frame diagram of a coded device and its corresponding digital signal according to the current invention.

FIG. 6 is a truth table containing the coded device's digital signals and their corresponding analog signals according to the current invention.

FIG. 7 is a time frame diagram of the conversion of signals from digital to analog according to the current invention.

FIG. 8 is a schematic diagram of the conversion of signals from digital to analog according to the current invention.

FIG. 9 is a diagram of the value sets generated by digitizing analog signals according to the current invention.

FIG. 10 is a flowchart of a method used for processing an image with an image processing system according to the current invention.

### DETAILED DESCRIPTION

The current invention increases the resolution of the image processing system such as a scanner in a way which involves neither modifying the physical size or properties of the code wheel or its regions, nor changing the scanner's media feeding velocity in any manner. Instead, a converter to transform multiple digital signals generated by an encoder into respective multiple analog signals and a digitizer that generates value sets, which inform the scanning unit the exact instant when a scanning sequence should be initiated, are proposed by the current invention and discussed below.

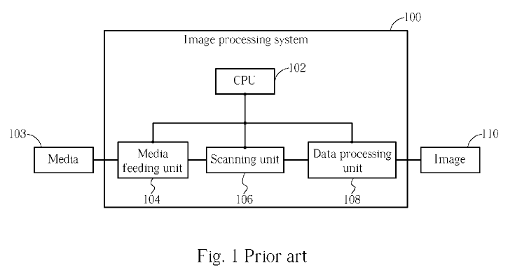

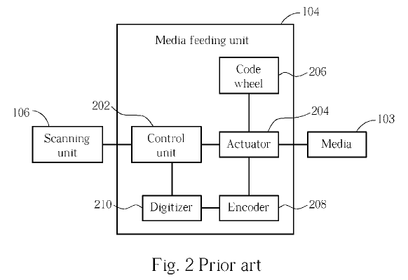

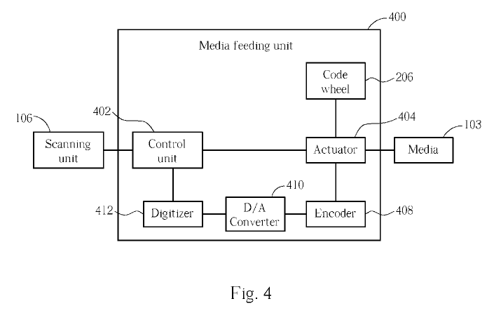

Please refer to FIG. 4 in conjunction with FIG. 1 and FIG. 2. The current invention's media feeding unit 400 comprises a control unit 402, an actuator 404, the code wheel 206, an encoder 408, a digital-to-analog converter (D/A converter) 410 and a digitizer 412. The control unit 402 is connected to the scanning unit 106, the digitizer 412 and the actuator 404, which is connected to the code wheel 206, the media 103 and the encoder 408. The encoder 408 is connected to the converter 410, which is connected to the digitizer 412. Note that the code wheel 206 could be any kind of coded device such as a coded strip.

The actuator 404 is virtually unchanged from the prior art. The encoder 408 is used to generate digital signals based on how light beams pass through the coded device 206 as described in the prior art. Furthermore, the encoder 408 generates additional digital signals by shifting the phase of existing signals by 90 degrees. However, the encoder 206 could generate numerous other distinct digital signals n by shifting the phase of the original digital signal by d degrees, where d could take any value between 0 and 180 degrees. The range of d is 0 to 180 degrees because a digital signal shifted by 180 degrees would lose its usefulness as it “turns back” into (i.e. is indistinguishable from) the initial digital signal.

The converter 410 converts the digital signals generated by the encoder 408 into respective analog signals, while the digitizer 412 generates 2-tuple value sets based on each pair of analog signals created by the converter 410. Obviously, if the encoder 408 generates n digital signals, the converter 410 could convert them into n analog signals, while the digitizer could generate value sets with as many as n values inside.

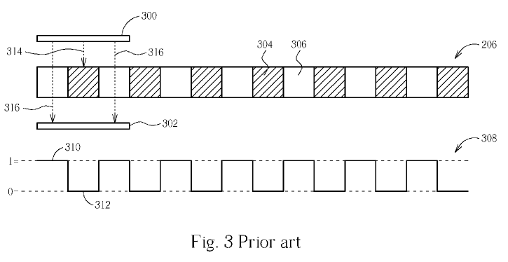

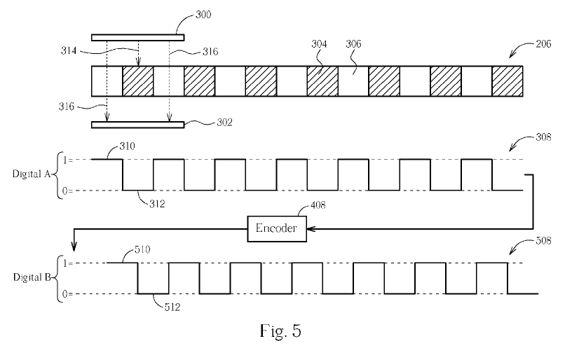

Please refer to FIG. 5 in conjunction with FIG. 2 and FIG. 3. FIG. 5 depicts the prior art digital signal A 308 that has a 1 value 310 when the light beam 316 generated by the light source 300 passes through a transparent region 306 the code wheel 206 and it's captured by the sensor 302. The digital signal A 308 has a 0 value 312 when the light beam 314 is blocked by an opaque region 304 of the code wheel 206. According to the current invention, once the digital signal A 308 is generated by the encoder 408, the encoder 408 generates digital signal B 508 by shifting the phase of digital signal A 308 by 90 degrees. The digital signal B 508 is comprised of alternating 1 values 510 and 0 values 512.

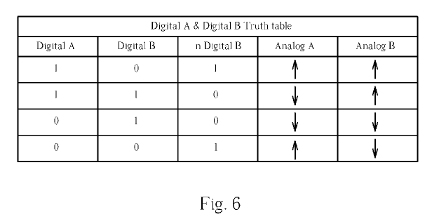

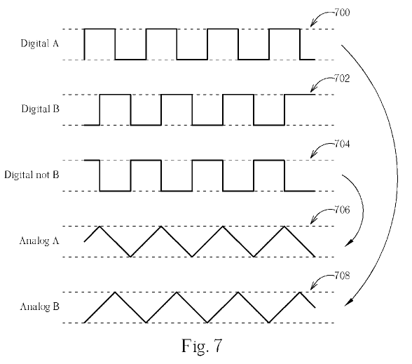

The conversion logic of the converter component, which converts digital signals into analog signals is illustrated by FIG. 6 and FIG. 7, and should be observed in conjunction with FIG. 3 and FIG. 5. According to the current invention, the D/A converter 410 is used to further transform digital signal A 308 and digital signal B 508, the end products of the encoder 408, into analog signals.

Firstly, FIG. 6. shows a truth table, which has the digital signal A 308, the digital signal B 508, a digital signal not(B), which is the inverse of digital signal B 508, and analog signals A and B. Digital signal B 508 has been derived by shifting the phase of digital signal A 308 by 90 degrees as it has been described above. In terms of binary logic, this means that for every 1 value of digital A, digital B can either have a 0 value or a 1 value. Additionally, for every 0 value of digital A, digital B can have a 0 value or a 1 value. This has been appropriately represented in the truth table. Additionally, the binary value for digital not(B) is obtained by taking the binary inverse of digital B. Hence the 1s become 0s and vice-versa.

Analog A is generated from digital not(B) by having the direct correlation between digital not(B) and analog A be interpreted as follows: if digital not(B) has a 1 value, analog A is interpreted to be increasing, hence an “up” arrow is placed in the corresponding box for analog A. Conversely, if digital not(B) has a 0 value then analog A is interpreted to be decreasing, hence a “down” arrow is placed in the corresponding box of the analog A signal.

Conversely, analog B is generated from digital A by having the 1 values of digital A correspond to an “up” arrow for analog B, while a 0 value for digital A corresponds to a “down” arrow in the respective analog B box in the truth table.

The binary logic in the truth table of FIG. 6, is graphically represented in FIG. 7. Here, digital A 700 is converted into analog B 708. In addition, digital B 702 is converted to not(digital B) 704 which is then used to generated analog A 706. It is to be noted that analog signals A 706 and B 708, are shown in FIGS. 7, 8 and 9 as triangular analog signals, however, they could also be sinusoidal analog signals.

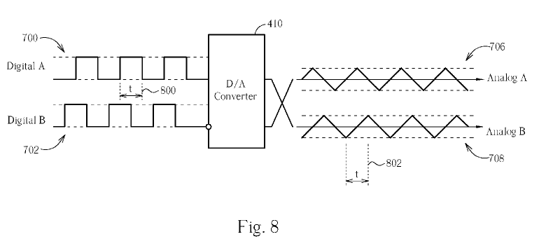

Please refer to FIG. 8 in conjunction with FIG. 7 and FIG. 4. The D/A converter 410 itself is illustrated in FIG. 8. The digital A 700 and the inverse of digital B 702 are fed into the converter 410, which generates analog A 706 from the inverse of digital B 700 and analog B 708 from digital A 700. The t 800 is used to portray a half-cycle for digital A 700, while t 802 is used to show a half-cycle for the corresponding analog B 708 in order for the transformation and the correlation from digital to analog to be more easily understood.

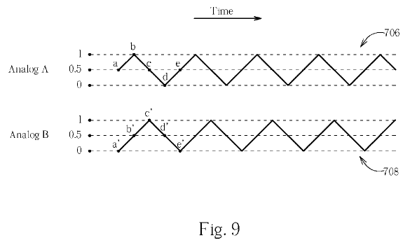

Please refer to FIG. 9 in conjunction with FIG. 7. FIG. 9 illustrates the logic of the digitizer component, which generates value sets based on the analog signals created by the converter. A complete cycle on analog A 706 starts at point a (inclusively), includes points b, c and d and ends at point e (exclusively). Conversely, on analog B 708 a complete cycle starts at a′ (inclusively), includes b′, c′ and d′, and ends at e′ (exclusively). It is to be noted that a and a′ occur at the same time instance. The same is true for b, b′ and c, c′ and d, d′ and e, e′. By combining a and a′ into a 2-value pair Vₐ=(a, a′) and doing the same for b, b′ and c, c′ and d, d′, 4 distinctive value sets Vₐ, V_{b}, V_{c} and V_{d} are created as shown on the FIG. 7.

The values sets in this case would therefore be:

Vₐ=(a, a′) where a=0.5 and a′=0, hence Vₐ=(0.5, 0)

V_{b}=(b, b′) where b=1 and b′=0.5, hence V_{b}=(1, 0.5)

V_{c}=(c, c′) where c=0.5 and c′=1, hence V_{c}=(0.5, 1)

V_{d}=(d, d′) where d=0 and d′=0.5, hence V_{d}=(0, 0.5)

As it can be seen, these value sets are distinguishable from each other, whereas in the prior art, containing only the values of 0 or 1 based on a digital signal they would be indistinguishable, henceforth the scanning would occur only once for every group of indistinguishable value sets.

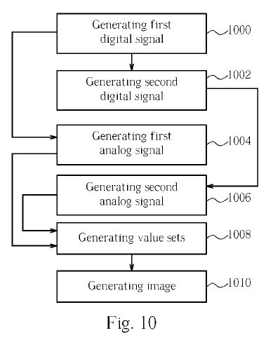

Please refer to FIG. 10. FIG. 10 depicts a flowchart diagram of the method used by the image processing system to process an image according to the present invention. The method of using the image processing system to process an image comprises following steps but not limited to following sequence:

Step 1000: the encoder 408 generates a first digital signal according to feedback from the code wheel 206;

Step 1002: the encoder 408 generates a second digital signal according to the first digital signal;

Step 1004: the converter 410 generates a first analog signal according to the first digital signal;

Step 1006: the converter 410 generates a second analog signal according to the second digital signal;

Step 1008: the digitizer 412 generates value sets according to the first and second analog signals;

Step 1010: the image processing system 100 generates an image.

The principal advantage of the current invention over prior art is imparted by the use of 2-tuple value sets based on analog signals. These value sets permit the scanning mechanism to scan a more specific area of the media, even though the media is being drawn in at the same speed as in the prior art.

In the prior art, the scanning mechanism was activated solely in direct proportion to one digital signal, whose values could either be 0 or 1, which depended on the number of transparent/opaque regions on the code wheel. Hence, this limited the scanning to be activated only in direct proportion to the number of different regions on the code wheel 206.

On the other hand, in the current invention the distinct value sets generated by the current invention allow the scanning mechanism to be triggered 4 for every one time that it was triggered in the prior art. This will increase resolution by a factor of 4.

Furthermore, if the value sets contain more than two elements, which would be achieved by having more than two analog signals, would translate into even more distinct value sets within each cycle of the analog signals, meaning even higher resolution. Conversely, additional distinct value sets can be generated, by taking more coordinates in each period, such as a, a′ and b, b′ in FIG. 9, from the analog signals, resulting in an added resolution boost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method comprising:
moving a coded device;
generating a first digital signal by detecting movement of the coded device;
generating a second digital signal according to the first digital signal;
generating a first analog signal according to the first digital signal;
generating a second analog signal according to the second digital signal;
generating value sets from the first and second analog signals; and
generating an image according to the value sets.

2. The method of claim 1 wherein moving the coded device is moving a code strip, and generating the first digital signal by detecting movement of the coded device is generating the first digital signal by detecting movement of the code strip.

3. The method of claim 1 wherein moving the coded device is rotating a code wheel, and generating the first digital signal by detecting movement of the coded device is generating the first digital signal by detecting rotation of the code wheel.

4. The method of claim 1 wherein generating the first analog signal according to the first digital signal is generating a first triangular signal according to the first digital signal.

5. The method of claim 4 wherein generating the second analog signal according to the second digital signal is generating a second triangular signal according to the second digital signal.

6. The method of claim 1 wherein generating the first analog signal according to the first digital signal is generating a first sinusoidal signal according to the first digital signal.

7. The method of claim 6 wherein generating the second analog signal according to the second digital signal is generating a second sinusoidal signal according to the second digital signal.

8. The method of claim 1 further comprising:
generating a third digital signal according to the first digital signal; and
generating a third analog signal according to the third digital signal;
wherein generating value sets from the first and second analog signals is generating value sets from the first, second and third analog signals.

9. The method of claim 1 wherein generating the second analog signal according to the second digital signal comprises:
generating a third digital signal according to the second digital signal; and
generating the second analog signal according to the third digital signal.

10. The method of claim 1 wherein the first and second digital signals have a 90-degree phase difference.

11. The method of claim 1 further comprising scanning a document wherein the image is generated from the document.

12. The method of claim 1 further comprising printing the image.

13. An image processing system comprising:
a media feeding unit comprising:
an actuator;
a coded device connected with the actuator;
an encoder for generating encoded signals based on movements of the coded device;
a converter connected with the encoder for converting encoded signals into analog signals; and
a digitizer for generating value sets from the analog signals; and
a scanning unit for scanning a document; and
a data processing unit connected to the scanning unit for generating an image according to the value sets.

14. The image processing system of claim 13 further comprising a central processing unit for controlling the operations of the media feeding unit, the scanning unit and the data processing unit.

15. The image processing system of claim 13 further comprising a data printing unit for printing the image generated by the data processing unit.

16. The image processing system of claim 13 wherein the coded device is a code wheel, and the actuator and code wheel are coaxial.

17. The image processing system of claim 13 wherein the coded device is a code strip.
